(19) United States
(12) Patent Application Publication
(10) Pub. No.: US 2015/0182907 A1
(43) Pub. Date: Jul. 2, 2015

(54) CARBON DIOXIDE ABSORBING AGENT, CARBON DIOXIDE CAPTURE SYSTEM AND METHOD OF SLOWING THE DEGRADATION OF THE CARBON DIOXIDE ABSORBING AGENT

(71) Applicants: Yu-Xiao Lin, Hsinchu (TW); Chung-Sung Tan, Hsinchu (TW); Cheng-Hsiu Yu, Hsinchu (TW)

(72) Inventors: Yu-Xiao Lin, Hsinchu (TW); Chung-Sung Tan, Hsinchu (TW); Cheng-Hsiu Yu, Hsinchu (TW)

(21) Appl. No.: 14/323,600

(22) Filed: Jul. 3, 2014

(30) Foreign Application Priority Data
Dec. 30, 2013 (TW) 102149003

(51) Int. Cl. B01D 53/14; B01D 53/62

(52) U.S. Cl. CPC B01D 53/1493; B01D 53/62; B01D 2252/604; B01D 2252/204; B01D 2252/20447; B01D 2252/20415; B01D 2252/504

(57) ABSTRACT

The present invention discloses a carbon dioxide (CO2) absorbing agent, a CO2 capture system and a method of slowing down the degradation of the CO2 absorbing agent. More specifically, by adding additives of inorganic salts to the CO2 absorbing agent to act as an oxygen inhibitor, the dissolved oxygen value thereof would be decreased so as to slow down the degradation of the CO2 absorbing agent.

### PRIORITY CLAIM

This application claims the benefit of the filing date of Taiwan Patent Application No. 102149003, filed Dec. 30, 2013, entitled “CARBON DIOXIDE ABSORBING AGENT, CARBON DIOXIDE CAPTURE SYSTEM AND METHOD OF SLOWING THE DEGRADATION OF THE CARBON DIOXIDE ABSORBING AGENT,” and the contents of which is hereby incorporated by reference in its entirety.

### FIELD OF THE INVENTION

This present invention relates generally to a carbon dioxide (CO2) absorbing agent, CO2 capture system and method of slowing down the oxidative degradation of the CO2 absorbing agent; more specifically, the present invention uses additives of inorganic salts as oxygen inhibitors so as to decrease the dissolved oxygen value (DO value) of the absorbing agent so as to slow down the oxidative degradation thereof.

### BACKGROUND OF THE INVENTION

Massive amounts of greenhouse gas, such as of CO₂, CH₄, N₂O and SF₆, are released into the atmosphere since the start of the first industrial revolution, causing the greenhouse effect. Among the said greenhouse gasses, the one with the most impact is CO₂ (Haszeldine, 2009; IEA, 2012). According to the study, the concentration of CO₂ in the atmosphere has increased from 280 ppm to 398 ppm since the first industrial revolution and the concentration is still growing at a rate of about 2 ppm every year (IPCC, 2007; NOAA, 2013). An organization called the Intergovernmental Panel on Climate Change (IPCC) pointed out that in order to effectively control the global average rising temperature problem, CO₂ emissions must be strictly controlled. Moreover, nowadays, fossil fuel provides more than 85% of the world's electricity, and has also become one of the major sources of CO₂ emissions, wherein 43% of the total emission are coming from fossil fuel-fired power plants. Therefore it is imperative to capture CO₂ from the major sources to cope with the global demand of carbon reduction (IEA, 2012; Mudhasakul et al, 2013).

Additionally, a technology called Post-Combustion Carbon Dioxide Capture (PCCC) is now being widely applied to capture CO₂ in the flue gas released from fossil fuel-fired power plants in order to decrease the CO₂ released into the atmosphere, where the PCCC technologies include chemical absorption, adsorption, cryogenic or membrane.

Among the said processes, chemical absorption is now rated as the most practical process in separating CO₂ from the flue gas released from fossil fuel-fired power plants (Rochelle, 2009) because of the high absorption efficiency. However, in the chemical absorption process, there are a couple of persistent and unsolved problems such as the equipment size, absorbing agent degradation and energy consumption.

In the chemical absorption process, an amine-group absorption agent such as monoethanolamine (MEA), methyldiethanolamine (MDEA) and diethylenetriamine (DETA) are usually utilized. The solvent that mixed with absorption agent can be water, diethyleneglycol or the mixture thereof. In the existing research, the reaction rate and loading capacity of the CO₂ of DETA is higher than MEA, but the vapor pressure is lower than MEA. Accordingly, the mixture of DETA and piperazine (PZ) has a higher CO₂ absorption performance than the mixture of MEA and PZ, resulting in a lower absorbing agent loss during the absorption and regeneration process.

Most of the gas released from fossil fuel-fired power plants (hereinafter called gas under treatment) comprises the impurities of, for example, fly ash (1000-10000 mg/m³), SOx (300-3000 ppm), NOx (100-1000 ppm) and oxygen (5-10%) (Chakravarti et al., 2001). The said impurities are very likely to react with an amine-group by irreversible reactions (Freeman et al., 2010; Dumee et al., 2012; Voice et al., 2013). Meanwhile, the absorbing agent of the amine-group is decomposed and degraded in the said reactions. For example, for each ton of CO₂ captured, 1.6 to 3.1 kg of MEA is consumed as an absorbing agent during the process (Arnold et al., 1982; Veltman et al., 2010). Furthermore, since MEA costs about USD$ 1800/ton, it costs about USD$ 2.3 million dollars for a power plant releasing a million tons of CO2 per year (Dumee et al., 2012). In addition, the cost of the MEA accounts for almost 10% of the total operation cost of the CO₂ capture process (Wang et al., 2012). Therefore, it is of high priority to find a way to avoid or slow down the degradation of the CO₂ absorbing agent.

Furthermore, it is known that oxygen is the impurity that most likely reacts with the CO₂ absorbing agent which causes oxidative degradation of the CO₂ absorbing agent. The amount of dissolved oxygen presenting in the CO₂ absorbing agent is proportional to the degradation amount of the absorbing agent.

Nowadays, sodium sulfite (Na₂SO₃) is mostly used in the industry as an oxygen inhibitor for slowing down the oxidative degradation. In practice, the Na₂SO₃ reacts with oxygen to form the sodium sulfate that consumes the oxygen. Apart from Na₂SO₃, there are various types of oxygen inhibitors that can be used for CO₂ capture, for example, as disclosed in the US patent publication number 2008096047.

### SUMMARY OF THE INVENTION

The use of an oxygen inhibitor increases the operating cost of the chemical absorption process. It is known that Na₂SO₃ is widely used in the industry as an oxygen inhibitor. However, refilling it and cleaning the resultant (sodium sulfate) are problems that exist. The present invention is different from the prior art in that the present invention decreases the DO value of the CO₂ absorbing agent by adding an inorganic salt compound therein as an oxygen inhibitor. While it is a physical means, there is no need for constant refilling and cleaning the resultant (sodium sulfate).

However, while the solubility of oxygen is decreased by addition of various types of inorganic salts, the solubility of CO₂ of the absorbing agent also decreases at the same time which decreases the CO₂ capture ability thereof for a certain amount. After a massive amount of experiments, the applicant discovered that using potassium chloride (KCl) as an oxygen inhibitor decreases the dissolved oxygen without sacrificing the CO₂ capture ability of the CO₂ absorbing agent.

In summary, one of the main aspects of the present invention is to provide a novel CO₂ absorbing agent that has a low oxidative degradation rate and a method of slowing down the degradation of the CO₂ absorbing agent caused by oxygen. More specifically, by mixing a unique oxygen inhibitor into the CO₂ absorbing agent, the oxidative degradation rate thereof may be slowed by decreasing the DO value of the absorbing agent. Furthermore, another aspect of the present invention is to provide a CO₂ capture system that applies the said absorbing agent and the method thereof.

### BRIEF DESCRIPTION OF THE DRAWINGS

FIG. 1A depicts a schematic diagram of an embodiment of the relationship between DO value and gas flow rate for the various formulas of the CO₂ absorbing agents of the present invention.

FIG. 1B depicts a schematic table of an embodiment of the average dissolved oxygen value for the various formulas of the CO₂ absorbing agents of the present invention.

FIG. 2A depicts a schematic diagram of an embodiment of the relationship between CO₂ capture efficiency and gas flow rate for the various formulas of the CO₂ absorbing agents of the present invention.

The FIG. 2B depicts a schematic table of an embodiment of the average percentage decreases in the CO₂ capture efficiencies for the CO₂ absorbing agent in the presence and absence of the inorganic salts under various operation conditions of the present invention.

FIG. 3 depicts a function block diagram of an embodiment of a method for slowing down the degradation of CO₂ absorbing agents of the present invention.

FIG. 4 depicts a function block diagram of an embodiment of a CO₂ capture system of the present invention.

### DETAILED DESCRIPTION

Firstly, there is a paper called [symbol] Effects of Inorganic Salts On Absorption of CO₂ and Oxygen in a Rotating Packed Bed [symbol] that was published by the applicant in July, 2013. The disclosure of the whole paper previously described is hereby incorporated by reference.

One of the aspects of the present invention discloses a new oxygen inhibitor of inorganic salt. More specifically, the present invention creatively applies an inorganic salt compound as an oxygen inhibitor in CO₂ absorbing agent, where the CO₂ absorbing agent can be applied to capture the CO₂ in a gas under treatment.

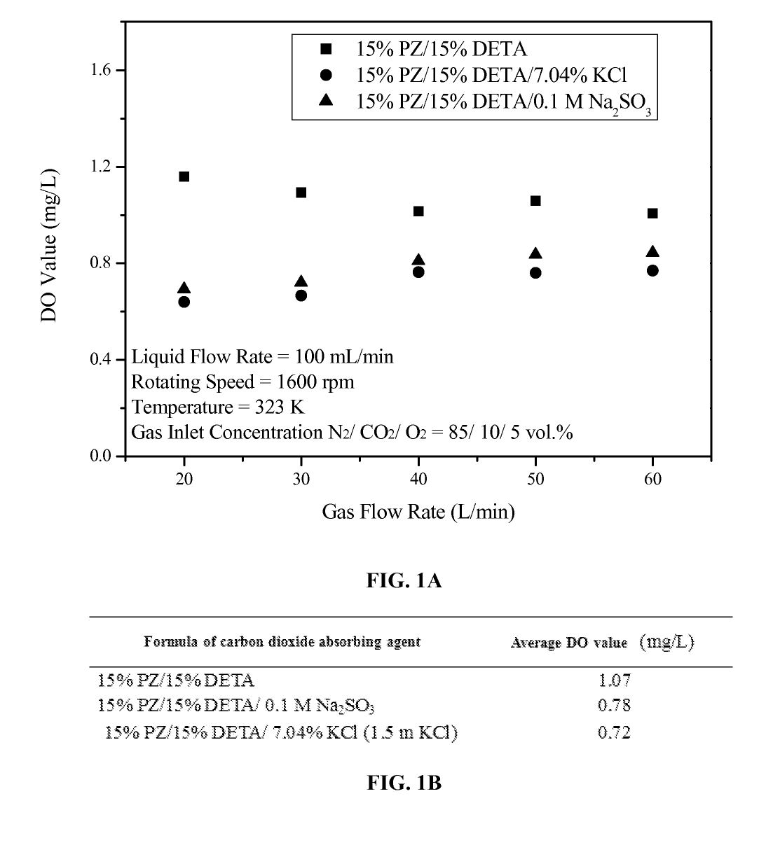

The inorganic salt of the present invention may, but not is limited to, comprise lithium bromide (LiBr), lithium chloride (LiCl), sodium chloride (NaCl), KCl or a chemical compound comprising the same. KCl is chosen as an example of the inorganic salt used for further explanation. Please refer to FIG. 1A and FIG. 1B. FIG. 1A depicts the comparison figure of the DO value to the gas flow rate for the various formulas of CO₂ absorbing agents. FIG. 1B depicts the average dissolved oxygen value of various formulas of the CO₂ absorbing agents.

For example, as shown in the figures, a solution of the CO₂ absorbing agent corresponding to a formula of 15% PZ/15% DETA is applied under the first operation condition to capture CO₂ of the gas under treatment released from fossil fuel-fired power plants and the average DO value is about 1.07 mg/L as shown in the table.

In the present embodiment, the gas under treatment previously described comprises N₂ having a volume percentage of 85%, CO₂ having a volume percentage of 10%, and O₂ having a volume percentage of 5%. Moreover, the first operation condition previously described includes a rotating packed bed (RPB) rotated under 1600 rpm, a temperature of 323 K and a liquid flow rate of 100 mL/min. Furthermore, the composition of the input gas and the inlet concentration thereof is N₂/CO₂/O₂ and 85/10/5 vol. % respectively.

Under the same operation condition, by adding an additive of 0.1 M Na₂SO₃ into the CO₂ absorbing agent, the average DO value thereof is reduced to 0.78 mg/L. In another way, if the said additive is replaced by 1.5 m KCl (7.04%), the average DO value thereof is further reduced to 0.72 mg/L. Accordingly, the figure clearly shows that the inorganic salt compound may effectively decrease the DO value of the CO₂ absorbing agent. In another way, the DO value of the CO₂ absorbing agent mixed with KCl is 7.7% lower than that mixed with Na₂SO₃ formula, which has better performance.

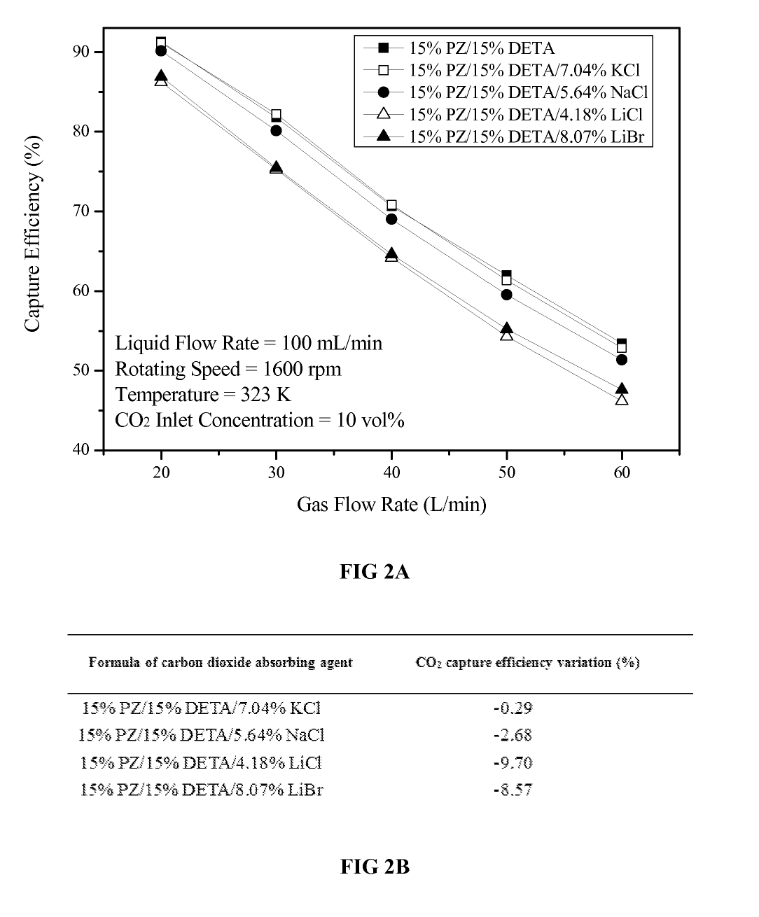

Please refer to FIG. 2A and FIG. 2B. FIG. 2A depicts a schematic diagram of an embodiment of the relationship between CO₂ capture efficiency and gas flow rate for the various formulas of CO₂ absorbing agents. FIG. 2B depicts a schematic table of an embodiment of the average percentage decreases in the CO₂ capture efficiencies for the CO₂ absorbing agents in the presence and absence of the inorganic salts under various operation conditions.

As shown in FIG. 2A and FIG. 2B, the five formulas of the CO₂ absorbing agents are listed in the following:

The first formula is 15% PZ/15% DETA;

the second formula is PZ/15%DETA/7.04% KCl;

the third formula is 15% PZ/15% DETA/5.64% NaCl;

the forth formula is 15% PZ/15% DETA/4.18% LiCl; and

the fifth formula 15%; 15% PZ/15% DETA/8.07% LiBr.

Furthermore, the gas under treatment is the same as FIG. 2A and is in a second operation condition. The second operation condition previously described includes a RPB rotated under 1600 rpm, a temperature of 323 K, and a liquid with a flow rate of 100 mL/min. Additionally, the composition of the input gas and the inlet concentration thereof is CO₂ at 10 vol. %.

As shown in FIG. 2A and 2B, the CO₂ capture efficiency of all of the formulas decreases as the gas flow rate increases, with the worst capture efficiency of the formulas being LiCl, the efficiency thereof decreases for 9.7%. In contrast, the best capture efficiency of the formulas is KCl, which the CO₂ capture efficiency decreases only 0.3%, which is about less than one twentieth of the LiCl. It worth mentioning that the paper [symbol] Yasunishi, A., Yoshida, F., 1979. Solubility of Carbon Dioxide in Aqueous Electrolyte Solutions. Journal of Chemical and Engineering Data 24, 11-14 [symbol] discloses that the CO₂ solubility in solution having 1.5 m KCl at 298 K is only 66% in pure water. Therefore, by the teaching thereof, KCl has an adverse impact to the CO₂ solubility. Since the percentage of 0.3% of the present invention is obviously lower than the 66% of the prior art, it is clearly shown that the present invention overcomes the technical problem with improved performance. The improved performance is due to the beneficial effect of the salt effect caused by the addition of inorganic salt, and therefore improves the reaction rate between the absorbing agent and CO₂. Moreover, the CO₂ capture efficiency may further be increased when RPB was applied. It should be noted that, in practice, the weight percentage of KCl can be adjusted among 0.1% to 10% in accordance with the requirement of user. More specifically, a 6% to 8% percentage is preferred. In the present embodiment; the weight percentage of KCl is 7.04%.

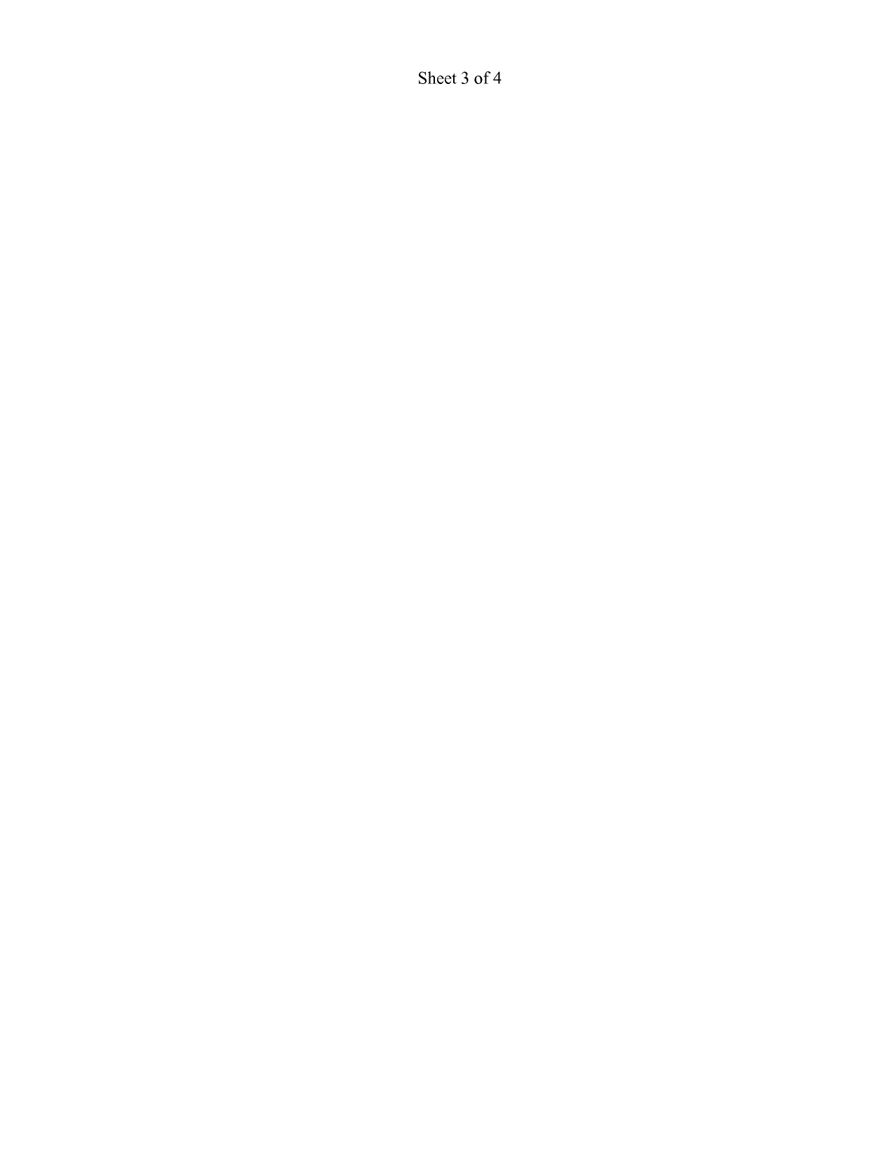

Another aspect of the present invention is to provide a method S to slow down the degradation of the CO₂ absorbing agents. The method comprises step S1 to step S3 as shown in FIG. 3. Step S1 is to prepare a CO₂ absorbing agent. Step S2 is to prepare an additive as an oxygen inhibitor; and step S3 is to mix the additive with the CO₂ absorbing agent. The definition of the CO₂ absorbing agent and additive was previously defined, and therefore will be omitted herein.

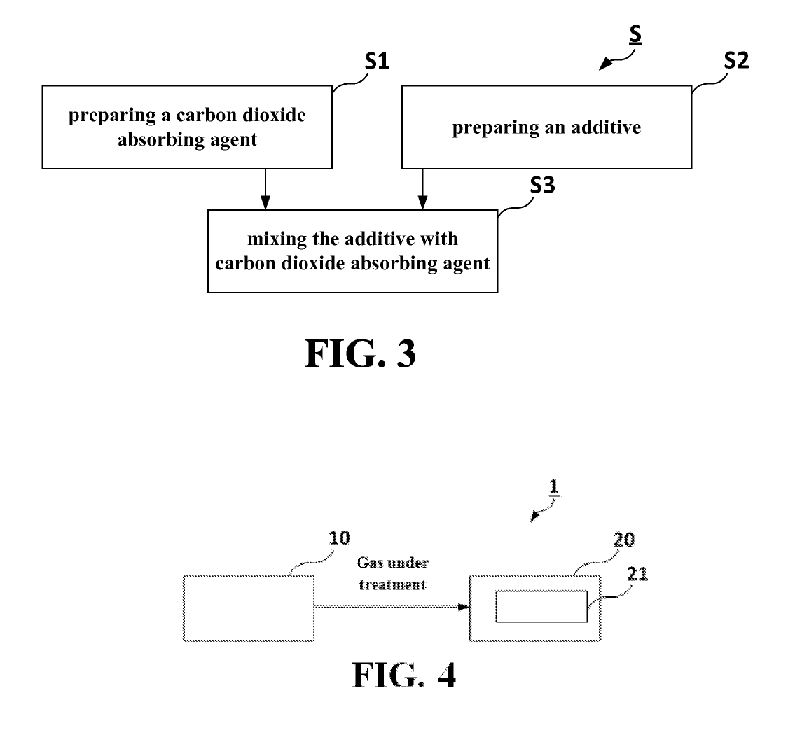

Moreover, another aspect of the present invention is to provide a CO₂ capture system 1 which can be applied in a fossil fuel-fired power plant. The system of the present invention is mainly composed of a chimney flue 10 and an absorption tower 20 connected therewith. The gas under treatment is first outputted from the chimney flue 10 of the fossil fuel-fired power plant. After cooling the gas under treatment and removing the impurities from the gas under treatment, the gas under treatment enters the absorption tower 20 via the bottom opening or any other entrance thereof in order to contact and react with the CO₂ absorbing agent 21 counter currently, achieving the goal of the CO₂ capture as shown in FIG. 4. In addition, the CO₂ absorbing agent 21 may comprise at least an additive of an oxygen inhibitor as previously described. The CO₂ absorbing agent 21 and additive can be at least an amine-group absorbing agent and at least an inorganic salt compound respectively, such as 15% PZ/15%DETA/7.04% KCl.

In summary, one of the main aspects of the present invention is to provide a novel CO₂ absorbing agent that has a low oxidative degradation and a method of slowing down the degradation of the CO₂ absorbing agent caused by oxygen. More specifically, by mixing a unique oxygen inhibitor with the CO₂ absorbing agent, the oxidative degradation thereof may be slowed down. Furthermore, another aspect of the present invention is to provide a CO₂ capture system applying the said absorbing agent and the method thereof.

With the example and explanations above, the features and spirits of the invention will be hopefully well described. Those skilled in the art will readily observe that numerous modifications and alterations of the device may be made while retaining the teaching of the invention. Accordingly, the above disclosure should be construed as limited only by the metes and bounds of the appended claims.

What is claimed is:

1. A carbon dioxide (CO₂) absorbing agent for CO₂ capture from a gas under treatment, comprising:
at least an amine-group CO₂ absorbing agent;
at least an oxygen inhibitor; and
at least a solvent, the said solvent comprising water, diethyleneglycol or the mixture thereof.

2. The CO₂ absorbing agent of claim 1, wherein the amine-group CO₂ absorbing agent comprises piperazine (PZ).

3. The CO₂ absorbing agent of claim 1, wherein the amine-group CO₂ absorbing agent comprises diethylenetriamine (DETA).

4. The CO₂ absorbing agent of claim 1, wherein the amine-group CO₂ absorbing agent comprises the mixture of PZ and DETA.

5. The CO₂ absorbing agent of claim 1, wherein the oxygen inhibitor comprises an inorganic salt compound, the inorganic salt compound comprises lithium bromide (LiBr), lithium chloride (LiCl), sodium chloride (NaCl) or potassium chloride (KCl).

6. The CO₂ absorbing agent of claim 1, wherein the oxygen inhibitor comprises an inorganic salt compound, the inorganic salt compound comprises a mixture of LiBr, LiCl, NaCl or KCl.

7. The CO₂ absorbing agent of claim 1, wherein the oxygen inhibitor comprises an inorganic salt compound, the inorganic salt compound comprises KCl having a weight percentage between 6% to 8%.

8. A CO₂ capture system, comprising:
a chimney flue, outputting a gas under treatment, the gas under treatment comprising CO2; and
an absorption tower, connected with the chimney flue, the gas under treatment entering the chimney flue and reacting with a CO2 absorbing agent so as to decrease the CO2 in the gas under treatment, the CO₂ absorbing agent comprising a CO₂ absorbing agent.

9. The system of claim 8, the CO₂ absorbing agent comprising:
at least an amine-group CO2 absorbing agent;
at least an oxygen inhibitor; and
at least a solvent, the said solvent comprising water, diethyleneglycol or the mixture thereof.

10. The system of claim 9, wherein the oxygen inhibitor comprises an inorganic salt compound, the inorganic salt compound comprises lithium bromide (LiBr), lithium chloride (LiCl), sodium chloride (NaCl) or potassium chloride (KCl) or the mixture thereof.

11. The system of claim 10, wherein the inorganic salt compound comprises KCl.

12. The system of claim 11, wherein the KCl having a weight percentage between 6% to 8%.

13. A method for slowing down the degradation of CO₂ absorbing agent, comprising the following steps:
preparing a CO2 absorbing agent;
preparing an additive; and
mixing the additive with the CO2 absorbing agent for slowing down the degradation of the absorbing agent.

14. The method of claim 13, wherein the CO₂ absorbing agent and the additive comprise an amine-group CO₂ absorbing agent and KCl respectively.

15. The method of claim 14, wherein KCl has a weight percentage between 6% to 8%.
